(19) United States
(12) Patent Application Publication
(10) Pub. No.: US 2026/0067606 A1
(43) Pub. Date: Mar. 5, 2026

(54) EARPHONE WITH MICROPHONE ASSEMBLY

(71) Applicant: Apple Inc., Cupertino, CA (US)

(72) Inventors: Mann Patel, Boulder, CO (US); Benjamin A. Cousins, San Jose, CA (US); Daniel F. Tonderys, Boulder, CO (US); Anne M. Scalmanini, San Francisco, CA (US); Joel C. Yamasaki, Roseville, CA (US); Jarrett B. Lagler, San Francisco, CA (US)

(73) Assignee: Apple Inc., Cupertino, CA (US)

(21) Appl. No.: 19/279,808

(22) Filed: Jul. 24, 2025

Related U.S. Application Data
(60) Provisional application No. 63/688,175, filed on Aug. 28, 2024.

(51) Int. Cl. H04R 1/10; H04R 1/02

(52) U.S. Cl. CPC H04R 1/1016; H04R 1/02; H04R 1/105

(57) ABSTRACT

A non-occluding earphone including a device housing defining an internal cavity and including an ear-interface portion having an asymmetric shape, a port mesh disposed across the acoustic port forming a portion of an exterior surface of the earphone, an audio driver disposed within the internal cavity and aligned to emit sound through the acoustic port via a speaker acoustic path, a microphone disposed within the internal cavity, a microphone assembly coupled directly to the port mesh and disposed within the internal cavity at a location between the port mesh and the microphone, where the microphone assembly defines a microphone acoustic path from a point external to the earphone through the port mesh to the microphone that is fluidly isolated, within the internal cavity, from the speaker acoustic path up until the port mesh

### CROSS-REFERENCES TO RELATED APPLICATIONS

This application claims priority under 35 U.S.C. § 119 (e) to U.S. Provisional Application Ser. No. 63/688,175, filed Aug. 28, 2024, entitled “EARPHONE WITH MICROPHONE ASSEMBLY,” which is incorporated herein by reference in its entirety.

### BACKGROUND

Portable listening devices can be used with a wide variety of electronic devices such as portable media players, smart phones, tablet computers, laptop computers, stereo systems, and other types of devices. Portable listening devices have historically included one or more small speakers configured to be placed on, in, or near a user's ear, and include structural components that hold the speakers in place, and a cable that electrically connects the portable listening device to an audio source. Other portable listening devices can be wireless devices that do not include a cable and, instead, wirelessly receive a stream of audio data from a wireless audio source. Such portable listening devices can include, for instance, wireless earbud devices or in-ear hearing devices that operate in pairs (one for each ear) or individually for outputting sound to, and receiving sound from, the user.

### BRIEF SUMMARY

One aspect of the disclosure provides for a non-occluding earphone having a device housing defining an internal cavity, where the device housing may include an ear-interface portion having an asymmetric shape, an acoustic port formed through the ear-interface portion, a port mesh disposed across the acoustic port forming a portion of an exterior surface of the earphone, an audio driver disposed within the internal cavity and aligned to emit sound through the acoustic port via a speaker acoustic path that extends from the audio driver through the port mesh and the acoustic port to a point external to the earphone, a microphone disposed within the internal cavity, and a microphone assembly coupled directly to the port mesh and disposed within the internal cavity at a location between the port mesh and the microphone, where the microphone assembly may define a microphone acoustic path from a point external to the earphone through the port mesh to the microphone that is fluidly isolated, within the internal cavity, from the speaker acoustic path up until the port mesh.

Implementations may include one or more of the following features. The earphone where the microphone assembly may include an acoustic mesh spaced from the port mesh. The microphone assembly may include a hydrophobic membrane spaced from the acoustic mesh. The acoustic mesh may be positioned between the hydrophobic membrane and the port mesh. The microphone assembly may include one or more shim layers positioned between at least one of the acoustic mesh or port mesh. The one or more shim layers may include a plastic material. The microphone assembly may include chemically-resistant adhesive layers adhering the one or more shim layers to adjacent layers. The microphone assembly may define the microphone acoustic path through the acoustic mesh, the hydrophobic membrane, and the one or more shim layers to have a tortuous path. The microphone may form an air-tight seal with the microphone assembly. The earphone further may include a cowling coupling the microphone to the microphone assembly. The cowling may include a first cowling portion coupled to the port mesh and a second cowling portion coupling the microphone to the microphone assembly. The first cowling portion may lie along a first plane and the second cowling portion lies along a second plane offset from the first plane. The earphone further may include a processor that is configured to execute instructions to provide active noise cancellation.

Another aspect of the disclosure provides for an earphone having an unsealed acoustic architecture including a device housing defining an internal cavity, an acoustic port formed through a wall of the device housing, a port mesh disposed across the acoustic port forming a portion of an exterior surface of the earphone, an audio driver disposed within the internal cavity and aligned to emit sound through the acoustic port via a speaker acoustic path that extends from the audio driver through the port mesh and the acoustic port to a point external to the earphone, a microphone disposed within the internal cavity, and a microphone assembly coupled directly to the port mesh and disposed within the internal cavity at a location between the port mesh and the microphone, where the microphone assembly may define a microphone acoustic path from a point external to the earphone through the port mesh to the microphone that is fluidly isolated, within the internal cavity, from the speaker acoustic path up until the port mesh.

Implementations may include one or more of the following features. The earphone where the microphone assembly may include an acoustic mesh spaced from the port mesh and a hydrophobic membrane spaced from the acoustic mesh. The acoustic mesh may be positioned between the hydrophobic membrane and the port mesh. The microphone assembly may include one or more shim layers positioned between at least one of the acoustic mesh or port mesh. The earphone further may include a cowling coupling the microphone to the microphone assembly.

Yet another aspect of the disclosure provides for an earphone including a device housing defining an internal cavity, where, when the earphone is fit within an ear of a user, all acoustic air volumes within the internal cavity has a free-flowing air path to an ambient environment external to the earphone, an acoustic port formed through a wall of the device housing, a port mesh disposed across the acoustic port forming a portion of an exterior surface of the earphone, an audio driver disposed within the internal cavity and aligned to emit sound through the acoustic port via a speaker acoustic path that extends from the audio driver through the port mesh and the acoustic port to a point external to the earphone, a microphone disposed within the internal cavity, and a microphone assembly coupled directly to the port mesh and disposed within the internal cavity at a location between the port mesh and the microphone, where the microphone assembly may define a microphone acoustic path from a point external to the earphone through the port mesh to the microphone that is fluidly isolated, within the internal cavity, from the speaker acoustic path up until the port mesh.

Implementations may include one or more of the following features. The earphone where the microphone assembly may include an acoustic mesh spaced from the port mesh and a hydrophobic membrane spaced from the acoustic mesh.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a simplified illustration of an exemplary portable electronic listening device system having a host device configured as a smart phone, a case, and a pair of wireless listening devices configured as earbuds, according to some embodiments.

FIG. 2 depicts a simplified block diagram of various components of a portable wireless listening system according to some embodiments.

FIG. 3A depicts a front perspective view of an earphone according to some embodiments.

FIG. 3B depicts a rear perspective view of the earphone shown in FIG. 3A according to some embodiments.

FIG. 3C depicts a top view of the earphone shown in FIG. 3A according to some embodiments.

FIG. 4 depicts a simplified cross-sectional view of the earphone along Section A-A according to some embodiments.

FIG. 5 depicts an enlarged view of the microphone assembly shown in FIG. 4 according to some embodiments.

FIG. 6 depicts a detailed exploded view of the microphone assembly the microphone assembly shown in FIG. 4 according to some embodiments.

FIG. 7 depicts a perspective view of a cowling according to some embodiments.

### DETAILED DESCRIPTION

Earphones can include an active noise control (ANC) system to minimize incoming sounds (e.g., undesirable environmental noises) entering the user's ear. ANC systems generally include a feedforward, feedback, or hybrid ANC systems. Feedforward ANC systems include one or more microphones positioned on an external portion of the housing of the earphone to detect the incoming sounds around the earphone, predict the sound wave of the incoming sounds that the user will hear, and generate an anti-noise signal to cancel out the sound wave of that predicted incoming sounds. Feedback ANC systems generate anti-noise signals based on the incoming sounds detected by one or more internal microphones positioned in the housing of the earphone. As these microphones are positioned in the housing, they can measure the sound wave of the incoming sounds that more accurately represents the sound that will reach the user's ear (e.g., the user's eardrum) as well as monitoring the summation effects of the anti-noise signal on the undesirable incoming sounds to determine whether the anti-noise signal is effectively cancelling out the incoming sounds. Hybrid ANC systems include a combination of both systems by implementing both internal and external speakers.

Such ANC systems lends themselves to being used in canal phones (e.g., earphones that have an ear tip, such as a deformable ear tip, positioned in an ear canal of a user's ear that forms an airtight seal with a user's ear). In particular, the airtight seal of the canal phones lends itself to being used with ANC systems as such a seal better isolates the noise a user may hear from environmental noises outside of the earphones and the user's ear. However, providing ANC systems for earbuds that fit in a user's ear without being inserted into the ear canal (e.g., with no ear tip) can be challenging as such earbuds have a housing forming a “leaky architecture” (e.g., a housing having a non-occluding shape that does not form an airtight seal with a user's ear). This lack of an airtight seal can inhibit the ability of the internal microphone to accurately distinguish between the sound pressure inside the earphone as compared to the sound pressure received by the user's eardrum.

The present disclosure address these noted issues by providing an earbud having a microphone assembly that allows for incoming sounds entering the internal microphone to be fluidly isolated (e.g., acoustically isolated) from other portions of the internal cavity and for the microphone to be positioned closer to the acoustic port while providing protection to the microphone. In particular, the present disclosure provides an earphone with a housing having a leaky (or open fit) architecture that houses a microphone coupled to a microphone assembly that fluidly isolates the incoming sounds entering into the acoustic port from outside of the earphone and the outgoing sounds leaving the acoustic port from the driver positioned in the housing. Additionally, this microphone assembly can be directly coupled against the port mesh covering the acoustic port such that the incoming sounds entering into the acoustic port flows directly into the microphone through the microphone assembly. Further, the microphone assembly can include a number of layers that can help protect the microphone from ingress of unwanted substances. In this manner, as discussed in more detail below, the microphone assembly can enable ANC for earphones with a leaky architecture.

### Definitions

As used herein, the term “portable listening device” includes any portable device configured to be worn by a user and placed such that a speaker of the portable listening device is adjacent to or in a user's ear. A “portable wireless listening device” is a portable listening device that is able to receive and/or send streams of audio data from or to a second device without a wire connecting the portable wireless listening device to the second device using, for example, a wireless communication protocol.

Headphones are one type of portable listening device, headsets (a combination of a headphone and an attached microphone) are another, and hearing aids (in-ear devices that are designed to augment sounds from the surrounding environment to improve a user's hearing) are still an additional type of portable listening device. The term “headphones” represents a pair of small, portable listening devices that are designed to be worn on or around a user's head. Headphones convert an electrical signal to a corresponding sound that can be heard by the user. Headphones include both traditional headphones that are worn on or around a user's head and that include left and right ear cups connected to each other by a headband, and earphones (very small headphones that are designed to be fitted directly on or in a user's ear). Traditional headphones include both over-ear headphones (sometimes referred to as either circumaural or full-size headphones) that have ear pads that fully encompass a user's cars, and on-ear headphones (sometimes referred to as supra-aural headphones) that have ear pads that press against a user's ear instead of surrounding the ear.

The term “earphones” includes both small headphones, sometimes referred to as “earbuds,” that fit within a user's outer ear facing the ear canal without being inserted into the ear canal, and in-ear headphones, sometimes referred to as canal phones, that are inserted in the ear canal itself. Thus, earphones can be another type of portable listening device that are configured to be positioned substantially within a user's ear. As used herein, the term “ear tip”, which can also be referred to as an earmold, includes pre-formed, post-formed, or custom-molded sound-directing structures that at least partially fit within an ear canal. Ear tips can be formed to have a comfortable fit capable of being worn for long periods of time and can have different sizes and shapes to achieve a better seal with a user's ear canal and/or ear cavity.

### Example Wireless Listening System

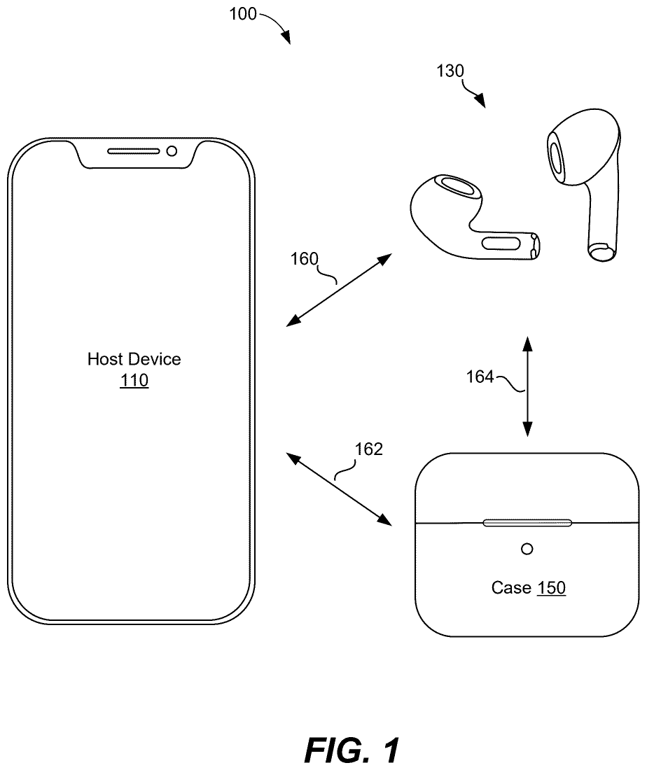

FIG. 1 is an example of a wireless listening system 100 according to some embodiments. The system 100 can include a host device 110, a pair of portable wireless listening devices 130 (e.g., left and right earphones) and a charging case 150. The host device 110 is depicted in FIG. 1 as a smart phone but can be any electronic device that can transmit audio data to the portable listening devices 130. Other, non-limiting examples of suitable host devices 110 include a laptop computer, a desktop computer, a tablet computer, a smart watch, an audio system, a video player, and the like.

As depicted graphically in FIG. 1, the host device 110 can be wirelessly communicatively coupled with the portable wireless listening devices 130 and the charging case 150 through wireless communication links 160 and 162. Similarly, portable wireless listening devices 130 can be communicatively coupled to the charging case 150 via wireless communication link 164. Each of the wireless communication links 160, 162 and 164 can be a known and established wireless communication protocol, such as a Bluetooth protocol, a WiFi protocol, or any other acceptable protocol that enables electronic devices to wirelessly communicate with each other. Thus, the host device 110 can exchange data directly with the portable wireless listening devices 130, such as audio data, that can be transmitted over the wireless link 160 to the wireless listening devices 130 for play back to a user, and audio data that can be received by the host device 110 as recorded/inputted from microphones in the portable wireless listening devices 130. The host device 110 can also be wirelessly communicatively coupled with the charging case 150 via the wireless link 162 so that the host device 110 can exchange data with the charging case, such as data indicating the battery charge level data for the case 150, data indicating the battery charge level for the portable wireless listening devices 130, data indicating the pairing status of the portable wireless listening devices 130.

The portable wireless listening devices 130 can be stored within the case 150, which can protect the devices 130 from being lost and/or damaged when they are not in use and can also provide power to recharge the batteries of the portable wireless listening devices 230 as discussed below. In some embodiments, the portable wireless listening devices 130 can also be wirelessly communicatively coupled with the charging case 150 via the wireless link 164 so that, when the devices are worn by a user, audio data from the case 150 can be transmitted to the portable wireless listening devices 130. As an example, the charging case 150 can be coupled to an audio source different than the host device 110 via a physical connection, e.g., an auxiliary cable connection. The audio data from the audio source can be received by the charging case 150, which can then wirelessly transmit the data to the wireless listening devices 130. That way, a user can hear audio stored on or generated by an audio source by way of the wireless listening devices 130 even though the audio source does not have wireless audio output capabilities.

As will be appreciated herein, the portable wireless listening devices 130 can include several features can enable the devices to be comfortably worn by a user for extended periods of time and even all day. Each portable wireless listening device 130 can be shaped and sized to fit securely between the tragus and anti-tragus of a user's ear so that the portable listening device is not prone to falling out of the ear even when a user is exercising or otherwise actively moving. Its functionality can also enable the wireless listening devices 130 to provide a user interface to the host device 110 so that the user may not need to utilize a graphical interface of the host device 110 for certain functions or operations of either the portable wireless listening devices or the host device. In other words, the wireless listening devices 130 can be sufficiently sophisticated that they can enable the user to perform certain day-to-day operations from the host device 110 solely through interactions with the wireless listening devices 130. This can create further independence from the host device 110 by not requiring the user to physically interact with, and/or look at the display screen of, the host device 110, especially when the functionality of the wireless listening devices 130 is combined with the voice control capabilities of the host device 110. Thus, in some instances the portable wireless listening devices 130 can enable a true hands-free experience for the user.

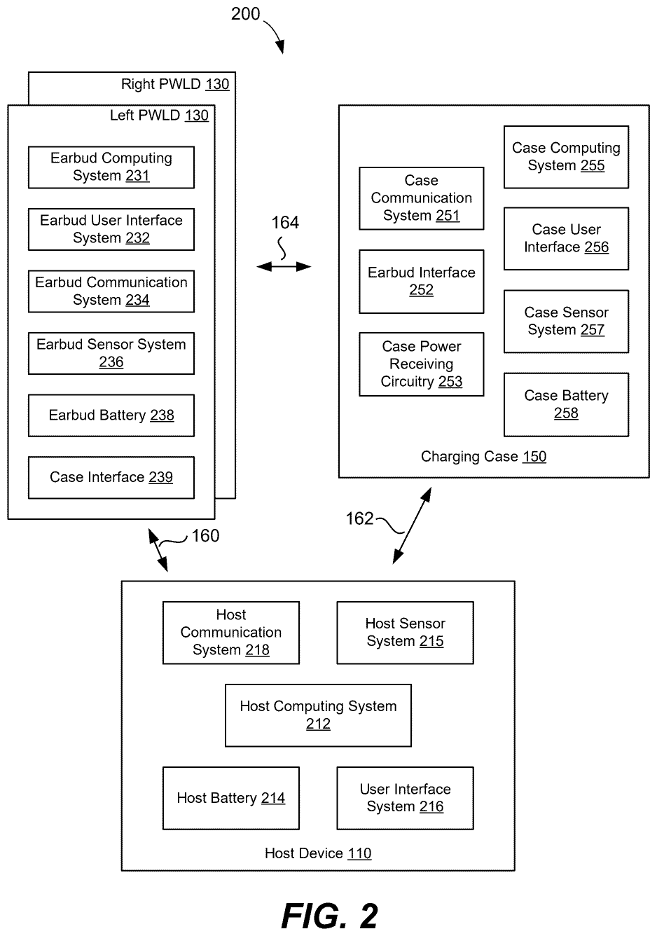

FIG. 2 is a simplified block diagram 200 of various components of the wireless listening system 100 according to some embodiments that includes a host device 110, a pair of portable wireless listening devices (PWLDs) 130 (e.g., a right PWLD 130 and a left PWLD 130) and a charging case 150. Each portable wireless listening device 130 can receive and generate sound to provide an enhanced user interface for the host device 110. For convenience, the discussion below refers to a single portable wireless listening device 130, but it is to be understood that, in some embodiments, a pair of portable listening devices can cooperate together for use in a user's left and right ears, respectively, and each portable wireless listening device in the pair can include the same or similar components.

The portable wireless listening device 130 can include a computing system 231 that executes computer-readable instructions stored in a memory bank (not shown) for performing a plurality of functions for the portable wireless listening device 130. For example, the computer system 231 includes instructions that provide ANC features to the portable wireless listening devices 130. These instructions can include analyzing incoming sounds entering an internal microphone (e.g., a microphone that is part of the earbud sensor system 236), determining an anti-noise signal that would cancel out those incoming sounds, and then emitting the anti-noise signal as a part of the outgoing sounds from a driver (e.g., a driver that is part of the user interface system 232) to cancel out the incoming sounds. The computing system 231 can be one or more suitable computing devices, such as microprocessors, computer processing units (CPUs), digital signal processing units (DSPs), field programmable gate arrays (FPGAs), application specific integrated circuits (ASICs) and the like.

The computing system 231 can be operatively coupled to a user interface system 232, communication system 234, and a sensor system 236 for enabling the portable wireless listening device 130 to perform one or more functions. For instance, the user interface system 232 can include a driver (e.g., speaker) for outputting sound to a user, one or more microphones for inputting sound from the environment or the user, one or more LEDs for providing visual notifications to a user, a pressure sensor or a touch sensor (e.g., a resistive or capacitive touch sensor) for receiving user input, and/or any other suitable input or output device. The communication system 234 can include wireless and wired communication components for enabling the portable wireless listening device 130 to send and receive data/commands from the host device 110. For example, in some embodiments, the communication system 234 can include circuitry that enables the portable wireless listening device 130 to communicate with the host device 110 over the wireless link 160 via a Bluetooth or other wireless communication protocol. In some embodiments, the communication system 234 can also enable the portable wireless listening device 130 to wirelessly communicate with the charging case 150 via the wireless link 164. The sensor system 236 can include proximity sensors (e.g., optical sensors, capacitive sensors, radar, etc.), accelerometers, microphones, and any other type of sensor that can measure a parameter of an external entity and/or environment.

The portable wireless listening device 130 can also include a battery 238, which can be any suitable energy storage device, such as a lithium-ion battery, capable of storing energy and discharging stored energy to operate the portable wireless listening device 130. The discharged energy can be used to power the electrical components of the portable wireless listening device 130. In some embodiments, the battery 238 can be a rechargeable battery that enables the battery to be repeatedly charged as needed to replenish its stored energy. For instance, the battery 238 can be coupled to battery charging circuitry (not shown) that is operatively coupled to receive power from the charging case interface 239. The case interface 239 can, in turn, electrically couple with the earbud interface 252 of the charging case 150. In some embodiments, power can be received by the portable wireless listening device 130 from the charging case 150 via electrical contacts within the case interface 239. In some embodiments, power can be wirelessly received by the portable wireless listening device 130 via a wireless power receiving coil within the case interface 239.

The charging case 150 can include a battery 258 that can store and discharge energy to power circuitry within the charging case 150 and to recharge the battery 238 of the portable wireless power listening device 130. As mentioned above, in some embodiments, circuitry within the earbud interface 252 can transfer power to the portable wireless listening device 130 through a wired electrical connection between contacts in the charging case 150 that are electrically coupled to contacts in the portable wireless listening device 130 to charge the battery 238. While the case 150 can be a device that provides power to charge the battery 238 through a wired interface with the device 130 in some embodiments, in other embodiments the case 150 can provide power to charge the battery 238 through a wireless power transfer mechanism instead of or in addition to a wired connection. For example, earbud interface can include a wireless power transmitter coil that can couple with a wireless power receiving coil within the portable wireless listening device 130.

The charging case 150 can also include a case computing system 255 and a case communication system 251. The case computing system 255 can be one or more processors, ASICs, FPGAs, microprocessors, and the like for operating the case 150. The case computing system 255 can be coupled to the earbud interface 252 and can control the charging function of the case 150 to recharge the batteries 238 of the portable wireless listening devices 130, and the case computing system 255 can also be coupled to the case communication system 251 for operating the interactive functionalities of the case 150 with other devices, including the portable wireless listening device 130. In some embodiments, the case communication system 251 includes a Bluetooth component, or any other suitable wireless communication component, that wirelessly sends and receives data with the communication system 234 of the portable wireless listening device 130. Towards this end, each of the charging case 150 and portable wireless listening device 130 can include an antenna formed of a conductive body to send and receive such signals. The case 150 can also include a user interface 256 that can be is operatively coupled to the case computing system 255 to alert a user of various notifications. For example, the user interface can include a speaker that can emit audible noise capable of being heard by a user and/or one or more LEDs or similar lights that can emit a light that can be seen by a user (e.g., to indicate whether the portable listening devices 130 are being charged by the case 150 or to indicate whether the case battery 258 is low on energy or being charged).

The host device 110, to which the portable wireless listening device 130 is an accessory, can be a portable electronic device, such as a smart phone, tablet, or laptop computer. The host device 110 can include a host computing system 212 coupled to a battery 214 and a host memory bank 134 containing lines of code executable by the host computing system 212 for operating the host device 110. The host device 110 can also include a host sensor system 215, e.g., accelerometer, gyroscope, light sensor, and the like, for allowing the host device 110 to sense the environment, and a host user interface system 216, e.g., display, speaker, buttons, touch screen, and the like, for outputting information to and receiving input from a user. Additionally, the host device 110 can also include a host communication system 218 for allowing the host device 110 to send and/or receive data from the Internet or cell towers via wireless communication, e.g., wireless fidelity (WiFi), long term evolution (LTE), code division multiple access (CDMA), global system for mobiles (GSM), Bluetooth, and the like. In some embodiments, the host communication system 218 can also communicate with the communication system 234 in the portable wireless listening device 130 via a wireless communication link 162 so that the host device 110 can send audio data to the portable wireless listening device 130 to output sound, and receive data from the portable wireless listening device 130 to receive user inputs. The communication link 162 can be any suitable wireless communication line such as Bluetooth connection. By enabling communication between the host device 110 and portable wireless listening device 130, the wireless listening device 130 can enhance the user interface of the host device 110.

### Example Earphone

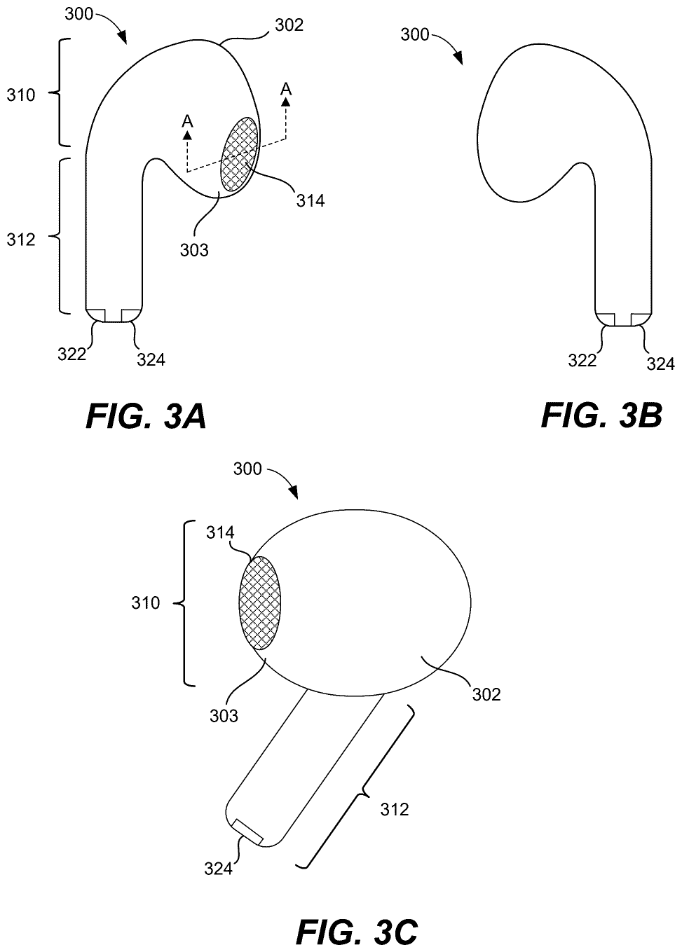

Portable wireless devices according to some embodiments can include a number of different features that provide a user with improved audio quality and a superior user experience as compared to many previously known portable wireless devices. To illustrate and explain some such features, reference is made to FIGS. 3A-3C, which are simplified views of a wireless earphone 300 according to some embodiments. The wireless earphone 300 can be representative of either of the portable wireless listening device 130 as shown in FIG. 1. Specifically, FIG. 3A is a simplified plan view of a first side of earphone 300, FIG. 3B is a simplified plan view of a second side, opposite the first side of earphone 300, and FIG. 3C is a simplified top view of earphone 300.

The earphone 300 includes a housing 302 that can be made from, for example, a hard radio frequency (RF) transparent plastic such as acrylonitrile butadiene styrene (ABS) or polycarbonate. In some embodiments, the housing 302 can be made from one or more components that can be bonded together (e.g., with tongue and groove joints and an appropriate adhesive) to form a monolithic housing structure with a substantially seamless appearance. The housing 302 forms a shell that defines an internal cavity in which the various components of the earphone 300 are housed. As depicted, the housing 302 can include two primary sections: a speaker housing 310 and a stem 312 that protrudes away from the speaker housing at an angle. As discussed below, the internal cavity within speaker housing 310 can hold an audio driver and battery while the cavity portion within stem 312 can hold a primary circuit board and other electronics. In some embodiments, the stem 312 can also include electrical contacts 322, 324 at the distal tip of the stem. The electrical contacts 322, 324 provide a physical interface that can be electrically coupled with corresponding electrical contacts in a corresponding charging case (e.g., the charging case 150). It is to be understood that embodiments are not limited to the particular shape and format of the housing 302 depicted in FIGS. 3A-3C. For example, in some embodiments the housing does not include a stem or similar structure and in some embodiment an anchor or other structure can be attached to or extend away from the housing to further secure the earbud to a feature of the user's ear.

The earphone 300 can be configured to have an open, unsealed acoustic architecture that is sometimes referred to as a “leaky acoustic architecture” or “open fit architecture.” That is, in some embodiments, the earphone 300 does not include a deformable ear tip that is included on canal phones and that is configured to be inserted into a user's ear canal to form an airtight seal between the ear tip and the user's ear. Instead, the speaker housing 310 can include an ear-interfacing portion 303 having an asymmetric shape amenable to in-ear-retention without being inserted into the ear canal. In this manner, the earphone 300 can be referred to as a non-occluding earphone in which, when the earphone is properly worn by a user, all acoustic air volumes within the earphone 300 have a free-flowing air path to the ambient environment external to the earphone 300.

The speaker housing 310 is the primary support mechanism for the earphone 300 when the earbud is positioned within a user's ear and the speaker housing 310 can be shaped to rest between a user's tragus and anti-tragus without putting unwanted pressure on the crus helix, which could lead to a source of discomfort when the earbud is engaged in a user's ear for a long period of time. Towards this end, the speaker housing 310 is contoured to allow the speaker housing portion to sit deep within the space between the tragus and anti-tragus of a user's ear to form a pseudo seal (sometimes referred to as a passive seal) between the housing 302 and the user's ear even though the earphone 300 is not a canal phone and does not include a deformable ear tip that is inserted into the user's ear canal. The pseudo seal allows the earphone 300 to have improved audio quality compared to other leaky architecture earbuds without creating potential pressure build-up within a user's ear that can be created by earbuds with deformable ear tips and that some users find uncomfortable.

The speaker housing 310 is further contoured such that certain surfaces of the housing are not in contact with any portion of an average user's ear. These non-contact portions provide locations for various features of the earphone 300 including a primary acoustic port 314 defined through a wall of the speaker housing 310 (e.g., through the ear-interface portion 303) that provides an acoustic pathway for sound generated by a driver (not shown in FIGS. 3A-3C) within the speaker housing 310 to reach a user's ear canal. When the earphone 300 is inserted in a user's ear, the acoustic port 314 is positioned at a location that is generally not in physical contact with the user's ear and adjacent to but spaced slightly apart from the user's ear canal. In some embodiments, the acoustic port 314 can be covered by an acoustic membrane and mesh as described below.

### 1. Microphone Stack Assembly

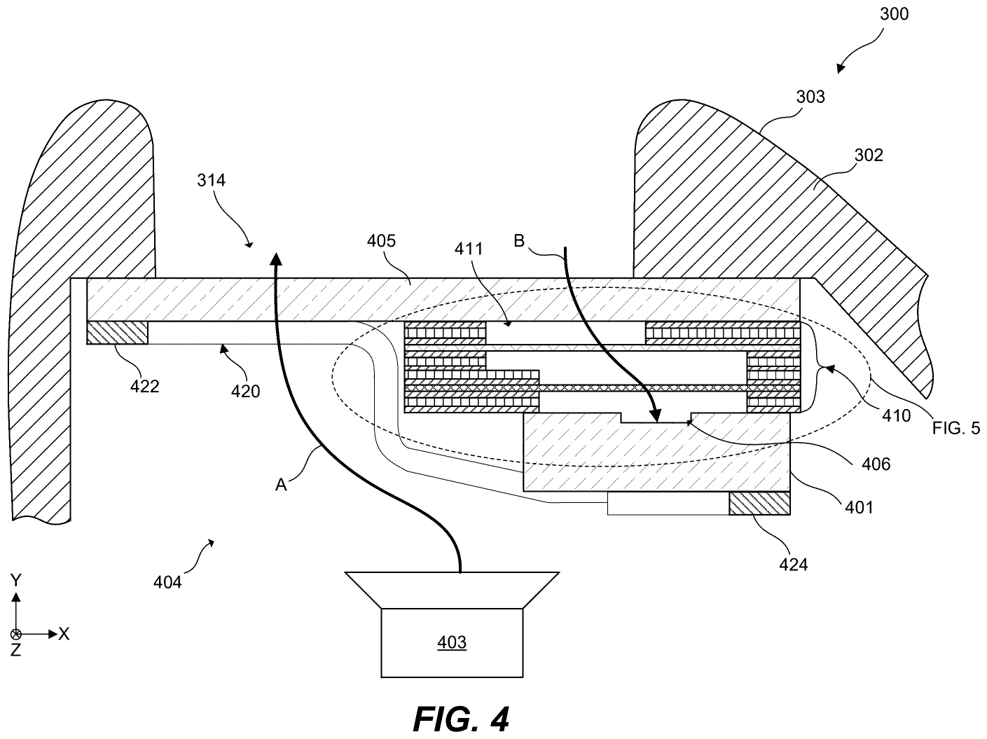

FIG. 4 depicts the earphone 300 along Section A-A. The housing 302 defines an internal cavity 404 housing a port mesh 405, microphone assembly 410, a microphone 401 positioned on a circuit board 202, driver 403 (shown schematically), and cowling 420. The internal cavity 404 can house additional components not shown, such as a battery and other electronic components. The port mesh 405 is coupled to the housing 302 through various mechanical means (e.g., adhesive, fasteners, or the like) such that the port mesh 405 is positioned against the acoustic port 314 and forms an exterior surface of the earphone 300. The port mesh 405 can include multiple layers (not shown), such as a cosmetic mesh and acoustic mesh coupled with a stiffener using an adhesive (e.g., a pressure-sensitive adhesive layer). A greater discussion of an example port mesh (referred to as a snorkel mesh) can be found in U.S. Pat. App. Pub. No. 2022/0103930, the contents of which are incorporated in its entirety. Sounds may exit and enter the internal cavity 404 from the acoustic port 314 through the port mesh 405.

The microphone assembly 410 is directly coupled against the port mesh 405. For example, there are no intervening layers between the microphone assembly 410 and the port mesh 405. The microphone 401 is coupled to the microphone assembly 410. The microphone 401 is coupled to the microphone assembly 410 with an airtight seal.

As noted above, in conventional designs, providing ANC with earphones having a leaky architecture can prove challenging due to the lack of airtight seal between the earphones and the user's ear. This leaky architecture can increase the risk that outgoing sounds from the driver mixes with the incoming sounds into the microphone, resulting in the anti-noise signal not effectively canceling out the environment noise external to the earphone. The microphone assembly 410 addresses this issue by allowing for the microphone 401 to be positioned closer to the acoustic port 314 while allowing incoming sound to flow directly into the microphone 401.

In particular, the microphone assembly 410 defines a microphone volume 411 for incoming sound to flow through that is fluidly isolated, within the internal cavity 404, from other portions of the internal cavity 404. In other words, the microphone volume 411 may be in fluid communication with the other portions of the internal cavity 404 through the acoustic port 314 but is otherwise fluidly isolated from the other portions of the internal cavity 404 from within the internal cavity 404. The incoming sounds from external of the earphone 300 may flow along a microphone acoustic path B from exterior of the earphone 300 through the port mesh 405, the microphone volume 411 into a microphone opening 406 of the microphone 401. The microphone acoustic path B can be fluidly isolated from the outgoing sounds of the driver 403 flowing along a speaker acoustic path A from the driver 403 within the internal cavity 404, through the port mesh 405 and the acoustic port 314, out to a user's ear. In this manner, the microphone 401 can more accurately detect what environmental sounds a user may hear for use in ANC compared to conventional earphones.

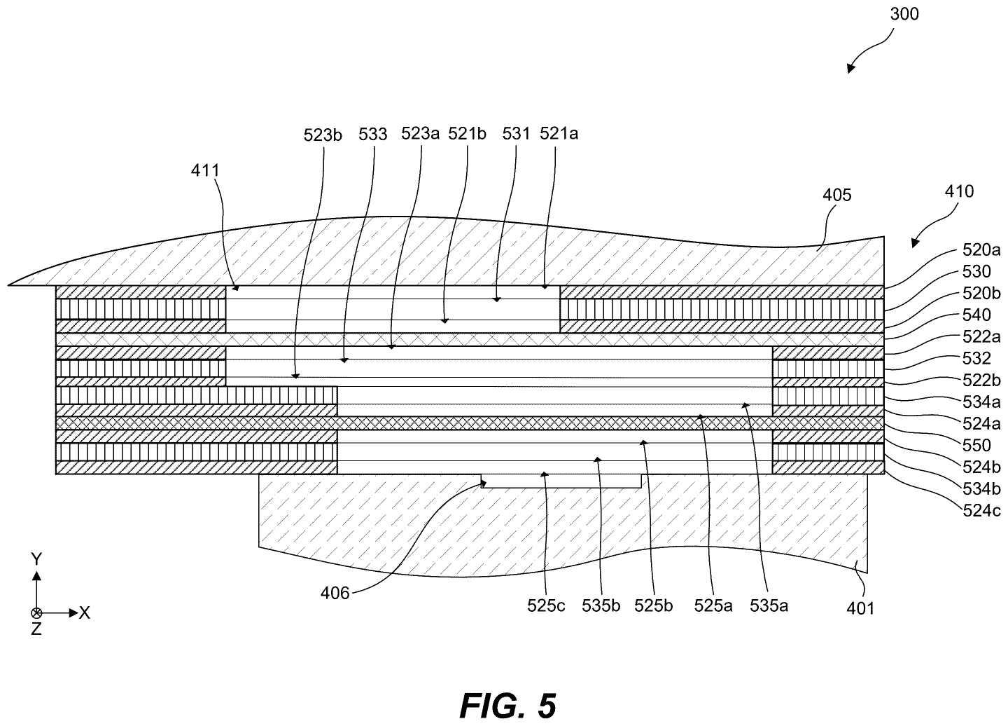

The microphone assembly 410 is offset from a central axis of the acoustic port 405 (e.g., along an X-Z plane) such that the microphone volume 411 is offset from the center of the acoustic port 405. In particular, a central axis of a top opening of the microphone assembly 410 along the Y-axis (e.g., defined by the adhesive apertures 521a, 521b and first shim aperture 531, as shown in FIG. 5) are offset from the central axis of the acoustic port 405. This may assist in fluidly isolating incoming sounds along the microphone acoustic path B from the outgoing sounds along the speaker acoustic path A by positioning the microphone assembly 410 and microphone 401 away from a portion of the flow path of the outgoing sounds.

The microphone assembly 410 includes a plurality of layers that assists in fluidly isolating the internal cavity 404 from the microphone volume 411 while also protecting the microphone 401 from accumulation of unwanted substances (e.g., earwax, skin oils, azelaic acid, or other substance that may enter the earphone 300) on the microphone assembly 410. For example, FIG. 5 depicts an enlarged view of the microphone assembly 410. The various layers may not be depicted to scale and, instead, may be illustrated as shown in FIG. 5 for illustration purposes. The microphone assembly 410 includes a first adhesive layer 520a coupling the microphone assembly 410 to the port mesh 405. The microphone assembly 410 includes a first shim layer 530 coupled between the first adhesive layer 520a and a second adhesive layer 520b.

The microphone assembly 410 includes an acoustic mesh 540 coupled between the second adhesive layer 520b and a third adhesive layer 522a. The acoustic mesh 540 can be formed of a pliable, porous material, such as a porous polyester, to allow incoming sounds to flow through the acoustic mesh 540 while also minimizing ingress of unwanted substances further into the microphone volume 411. The microphone assembly 410 includes a second shim layer 532 coupled between the third adhesive layer 522a and a fourth adhesive layer 522b, and a third shim layer 534a coupled between the fourth adhesive layer 522b and a fifth adhesive layer 524a.

The microphone assembly 410 includes a membrane 550 coupled between the fifth adhesive layer 524a and a sixth adhesive layer 524b. The membrane 550 can be an air permeable membrane (e.g., a polymer membrane, such as a polytetrafluoroethylene, or the like) that acts as a complex impedance. Such an air impermeable membrane can provide protection from the ingress of unwanted substances compared to other materials, such as a woven mesh. The membrane 550 can be tensioned to minimize the impact to incoming sounds by tuning the vibration such that they act as acoustically transparent as possible. The membrane 550 can be formed of a hydrophobic material to minimize the ingress of liquid past the membrane 550 from the port mesh 405 further into the microphone volume 411.

The microphone assembly 410 includes a fourth shim layer 534b coupled between the sixth adhesive layer 524b and a seventh adhesive layer 524c. The seventh adhesive layer 524c couples the microphone 401 to the microphone assembly 410. In some embodiments, the microphone can be positioned on a circuit board defining an opening for incoming sound to flow into the microphone and the seventh layer can couple the microphone assembly to the circuit board. The seventh adhesive layer 524c extends past the microphone 401 along the X-Z plane such that the seventh adhesive layer 524c has a greater surface area in the X-Z plane than the top surface of the microphone 401 (e.g., the highest surface of the microphone 401 along the Y-axis).

The first adhesive layer 520a defines a first adhesive aperture 521a, the first shim layer 530 defines a first shim aperture 531, and the second adhesive layer 520b defines a second adhesive aperture 521b. The adhesive layers 520a, 520b and first shim layer 530, and the adhesive apertures 521a, 521b and first shim aperture 531 may share similar dimensions. The third adhesive layer 522a defines a third adhesive aperture 523a, the second shim layer 532 defines a second shim aperture 533, and the fourth adhesive layer 522b defines a fourth adhesive aperture 523b. The adhesive layers 522a, 522b and second shim layer 532, and the adhesive apertures 523a, 523b and second shim aperture 533 may share similar dimensions. The third shim layer 534a defines a third shim aperture 535a, the fifth adhesive layer 524a defines a fifth adhesive aperture 525a, the sixth adhesive layer 524b defines a sixth adhesive aperture 525b, the fourth shim layer 534b defines a fourth shim aperture 535b, and the seventh adhesive layer 524c defines a seventh adhesive aperture 525c. The adhesive layers 524a, 524b, 524c and shim layers 534a, 534b, and the adhesive apertures 525a, 525b, 525c and the shim apertures 535a, 535b, may share similar dimensions.

The apertures 521a, 521b, 523a, 523b, 525a, 525b, 525c, 531, 533, 535a, 535b, and portions of the acoustic mesh 540 and membrane 550, defines the microphone volume 411 such that incoming sounds may flow through the apertures 521a, 521b, 523a, 523b, 525a, 525b, 525c, 531, 533, 535a, 535b, acoustic mesh 540, and membrane 550 into the microphone 401 while the adhesive layers 520a, 520b, 522a, 522b, 524a, 524b, 524c and shim layers 530, 532, 534a, 534b fluidly isolates this incoming sound within the internal cavity 404 from the other portions of the internal cavity 404. In this manner, the microphone assembly 410 can fluidly isolate the incoming sounds coming through the acoustic port 314 with the outgoing sounds from the driver 403 in the internal cavity 404, thus allowing the microphone 401 to more accurately detect what is entering the user's ear.

The shim layers 530, 532, 534a, 534b provides a desired height along the Y-axis between various layers of the microphone assembly 410, as well as providing distance between the port mesh 405 and the microphone 401, to minimize the effect from the ingress of unwanted substances (e.g., earwax or the like) into the microphone volume 411. For example, the accumulation of unwanted substances along the microphone assembly 410 can distort the incoming sounds entering the microphone 401 such that the incoming sound may be less representative of the external noise exterior of the earphone 300 that the user is hearing. This distortion can result in an anti-noise signal that does not effectively cancel out those external noses. Such an issue may be particularly problematic where the earphone 300 is a non-occluding earphone as the accumulation of unwanted substances on the acoustic mesh 540 may result in the computing system (e.g., the computing system 231, as shown in FIG. 2) interpreting the distorted incoming sound as the earphone 300 having a better seal in the user's ear, which can result in the anti-noise signal altering the sound quality of the outgoing sound from the driver 403 (e.g., decreasing the bass). Additionally, as the microphone 401 is positioned closer to the acoustic port 314, the microphone 401 is more exposed to unwanted substances and, therefore, at a greater risk of being damaged.

To address these issues, the microphone assembly 410 defines a first height within the microphone volume 411 between the port mesh 405 and the acoustic mesh 540. The layers 520a, 520b, 530 defines the apertures 521a, 521b, 531 to, cumulatively, have the first height along the Y-axis between the port mesh 405 and the acoustic mesh 540 to increase the distance that any unwanted substances from the port mesh 405 may accumulate to reach the acoustic mesh 540. In this manner, the user may have more time to notice and clean up these unwanted substances before the unwanted substances reaches the acoustic mesh 540 as well as generally increasing the lifespan of the earphone 300 by increasing the time it takes for unwanted substances to accumulate the microphone volume 411 at this first height.

The layers 520a, 520b, 522a, 522b, 524a, 524b, 524c, 530, 534a, 534b can define the apertures 521a, 521b, 523a, 523b, 525a, 525b, 525c, 531, 533, 535a, 535b to have varying dimensions along the X-Z plane according to a desired purpose of the corresponding layer 520a, 520b, 522a, 522b, 524a, 524b, 524c, 530, 534a, 534b. For example, the apertures 521a, 521b, 523a, 523b, 525a, 525b, 525c, 531, 533, 535a, 535b can be sized based on a distance from the acoustic port 514 and, therefore, exposure to unwanted substances (e.g., earwax or the like). In particular, the closer proximity of the apertures 521a, 521b, 523a, 523b, 531, 533 to the acoustic port 514 relative to the apertures 525a, 525b, 525c, 535a, 535b can result in a greater likelihood and speed that unwanted substances blocks the apertures 521a, 521b, 523a, 523b, 531, 533. As such, the size of the apertures 521a, 521b, 523a, 523b, 531, 533 may be different than the size of the apertures 525a, 525b, 525c, 535a, 535b to account for this increased risk of occlusion.

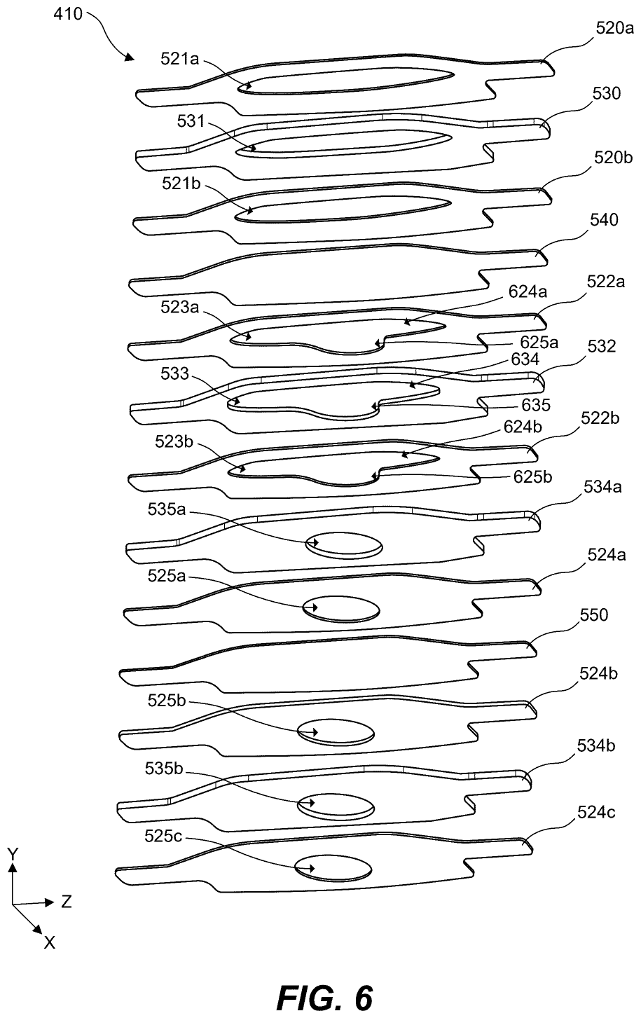

For example, FIG. 6 depicts an exploded view of the microphone assembly 410. The layers 520a, 520b, 522a, 522b, 530, 532 defines the corresponding apertures 521a, 521b, 523a, 523b, 531, 533 to have a larger width along the Z-direction and a larger circumference than the apertures 525a, 525b, 525c, 535a, 535b. These larger dimensions and circumference allow for more of the unwanted substance to accumulate in the apertures 521a, 521b, 523a, 523b, 531, 533 before affecting the quality of the incoming sound and lower layers. In this manner, the larger dimensions of the apertures 521a, 521b, 523a, 523b, 531, 533 allow for more time for a user to clear out unwanted substance accumulation (e.g., replacing or cleaning the acoustic port 314, port mesh 405, or the like) as well as generally increasing the lifespan of the microphone assembly 410 by increasing the time it takes for the microphone volume 411 to be blocked.

The apertures 523a, 523b, 533 defines lateral openings that each align with either apertures 521a, 521b, 531 or apertures 525a, 525b, 525c, 535a, 535b. For example, the third adhesive aperture 523a includes a first lateral adhesive opening 624a and a second lateral adhesive opening 625a, the second shim layer 532 includes a first lateral shim opening 634 and a second lateral shim opening 635, and the third adhesive aperture 522b includes a third lateral adhesive opening 624b and a fourth lateral adhesive opening 625b. Each of the openings 624a, 634, 624b are laterally offset from the openings 625a, 635, 625b in an X-direction. The openings 624a, 634, 624b are concentrically aligned along the Y-axis with the apertures 521a, 521b, 531 and the openings 625a, 635, 625b are concentrically aligned along the Y-axis with the apertures 525a, 525b, 525c, 535a, 535b. In this manner, incoming sound flows along the microphone acoustic path B in the microphone volume 411 in a tortuous path such that that the incoming sound flows through the first set of apertures 521a, 521b, 531 along a first axis, through the second set of apertures 523a, 523b, 533 at a transverse angle (e.g., at a non-parallel angle) to the first axis, and through the third set of apertures 525a, 525b, 525c, 535a, 535b along a second axis offset from, and substantially parallel to, the first axis along the X-axis. As such, the microphone acoustic path B is a tortuous flow path. The tortuous path of the microphone acoustic path B can assist in mitigating the effect that the accumulation of unwanted substances may cause to the microphone 401. Specifically, the tortuous path defined through the microphone volume 411 can minimize the risk that unwanted substances penetrates to the microphone 401 by providing a longer and more winding path for unwanted substances entering the microphone volume 411.

The adhesive layers 520a, 520b, 522a, 522b, 524a, 524b, 524c may include a chemically-resistant material that provides an adhesive quality to adjacent layers. For example, the adhesive layers 520a, 520b, 522a, 522b, 524a, 524b, 524c may be chemically-resistant while minimizing the risk of the adhesive layers 520a, 520b, 522a, 522b, 524a, 524b, 524c delaminating or failing due to the adhesive layers 520a, 520b, 522a, 522b, 524a, 524b, 524c being exposed to unwanted substances, such as earwax, skin oils, azelaic acid, or other substance that may enter the earphone 300. In this manner, the adhesive layers 520a, 520b, 522a, 522b, 524a, 524b, 524c may mitigate the risk that a leak may be formed between the microphone volume 411 and the internal cavity 404 within the internal cavity 404. For example, the adhesive layers 520a, 520b, 522a, 522b, 524a, 524b, 524c may include an adhesive, such as an epoxy adhesive, polyurethane adhesive, a polyimide adhesive, acrylic adhesive (e.g., acrylic styrene acrylate), benzoyl-based adhesive, or the like. The adhesive may be a hot melt adhesive, reactive hot melt adhesive, pressure sensitive adhesive, contact adhesive, or the like. The adhesive layers 520a, 520b, 522a, 522b, 524a, 524b, 524c may be a paste, liquid, film, solid, or the like. In one example, the adhesive layers 520a, 520b, 522a, 522b, 524a, 524b, 524c may include an ultraviolet adhesive (e.g., UV curing polyurethane adhesive). In other embodiments, the adhesive layers 520a, 520b, 522a, 522b, 524a, 524b, 524c may be a tape, such as an ultraviolet glue tape.

The shim layers 530, 532, 534a, 534b may also be made of a chemically-resistant rigid material. For example, the shim layers 530, 532, 534a, 534b metal or plastic material. In one example, the shim layers 530, 532, 534a, 534b can be made of one or more plastic materials, a polymer material, such as acrylonitrile butadiene styrene, polyethylene, polycarbonate, or the like. In another example, the shim layers 530, 532, 534a, 534b can be made of metal materials, such as nickel, steel, tin, aluminum, or the like. In yet other examples, the shim layers can be made of other materials having a rigid structure.

### 2. Cowling

Turning back to FIG. 2, the cowling 420 can provide increased support to the port mesh 405 and the microphone 401. Specifically, the cowling 420 includes a first cowling portion 422 that is coupled against the port mesh 405 and a second cowling portion 424 that is coupled against the microphone 401. The cowling 420 can be coupled to the port mesh 405 and the microphone 401 through a mechanical means (e.g., adhesive, fasteners, solder, brazing, or the like). This may be particularly useful to decrease the risk that the microphone assembly 410, or a portion thereof, may decouple from the port mesh 405 (e.g., due to a failure in one or more of the adhesive layers 520a, 520b, 522a, 522b, 524a, 524b, 524c) and fall within the internal cavity 404. In some embodiments, the cowling can be additionally coupled against the housing, or an additional component (not shown) within the internal cavity, to further secure the position of the microphone, the microphone assembly, and the port mesh within the internal cavity.

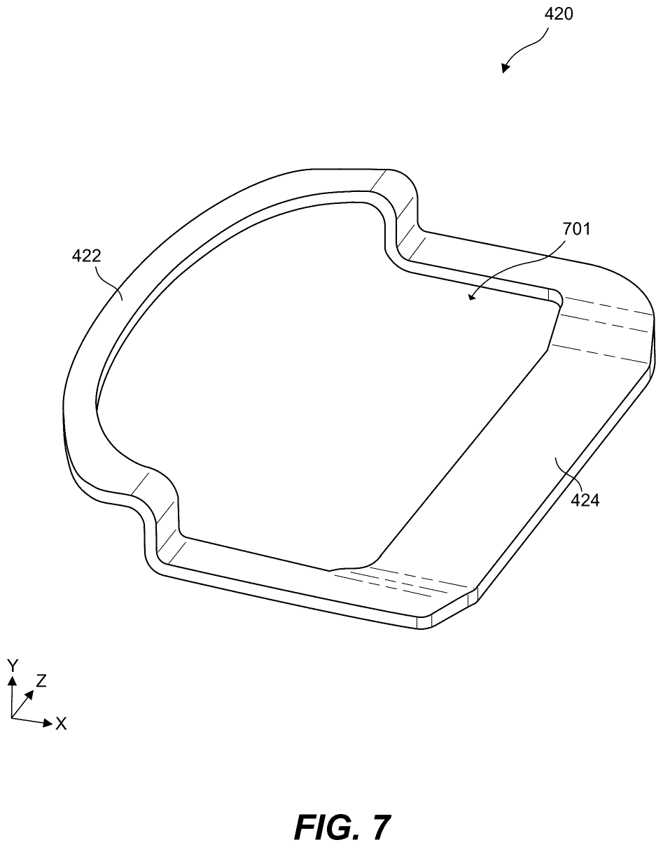

FIG. 7 depicts an isometric view of the cowling 420. The cowling can define a cowling opening 701 to receive other components of the earphone 300 therethrough. For example, the cowling 420 can receive portions of the microphone assembly 410 and microphone 401 within cowling opening 701. The second cowling portion 424 is offset from the first cowling portion 422 along the Y-axis to accommodate the height from a bottom surface of the port mesh 405 to a bottom surface of the microphone 401 (e.g., the height of the microphone assembly 410 and the microphone 401). The cowling 420 may be made of a rigid material, such as a metal (e.g., stainless steel), plastic, or the like.

### ADDITIONAL EMBODIMENTS

The foregoing description, for purposes of explanation, used specific nomenclature to provide a thorough understanding of the described embodiments. However, it will be apparent to one skilled in the art that the specific details are not required in order to practice the described embodiments. For example, while examples set forth above included a microphone assembly 410 that was directly attached to the port mesh 405, in other embodiments there can be one or more intervening layers or structures between the microphone assembly. In general, however, it is desirable to position the microphone as close as possible to the port mesh and it is also desirable to maintain complete isolation of the microphone acoustic path from the speaker acoustic path within the device housing. Additionally, although the port mesh 405 is depicted as positioned within the internal cavity 404 below the acoustic port 314, in other embodiments, the port mesh can be positioned outside of the internal cavity within the acoustic port.

Additionally, the microphone assembly can have more or less layers than as described above. For example, the microphone assembly may include less (or no) shim layers, and correspondingly no adhesive layer immediately preceding and succeeding that shim layer. In one example, there may only be one (or no) shim layer between the acoustic mesh and the membrane. In another example, there may no shim layer between the membrane and the microphone. In yet another example, there may be no shim layer between the acoustic mesh and the port mesh. In some embodiments, the shim layers may be an adhesive layer such that the adjacent adhesive layers are not included. In a yet further embodiment, there may be more shim layers and adhesive layers in the microphone assembly.

Although the above examples describes the microphone assembly 410, microphone volume 411, and microphone 401 as being offset from a central axis of the acoustic port 405, in other embodiments, the microphone assembly, the microphone volume, and/or the microphone can be aligned with the acoustic port. Additionally, although the seventh adhesive layer 524c is depicted as extending past the microphone 401 along the X-Z plane such that the seventh adhesive layer 524c, in other embodiments, the seventh adhesive layer may not extend past the microphone (e.g., having outer edges aligned with outer edges of the microphone or having a lesser surface area than the top surface of the microphone). As another example, one or more of the first and second adhesive layers and the first shim layer, and corresponding apertures, may have different dimensions. As yet another example, one or more of the third and fourth adhesive layers and second shim layer, and corresponding apertures, may have different dimensions. As a further example, one or more of the fifth, sixth, and seventh adhesive layers and third and fourth shim layers, and corresponding apertures, may have different dimensions.

Although the openings 624a, 634, 624b are depicted as being laterally offset from the openings 625a, 635, 625b in an X-direction, in other embodiments, the openings may be laterally offset from each other in other directions, such as the Z-direction. Additionally, although the microphone acoustic path B is described as having a tortuous flow path, in other embodiments, all the openings and apertures may be substantially aligned along the Y-axis such that the incoming sound flows along the microphone acoustic path in a substantially linear flow path.

In some embodiments, the cowling may include cowling portions that are co-planar. In a further embodiment, the earphone may not include a cowling. For example, an additional component may be coupled between the first cowling portion and the port mesh such that the cowling can provide support to the port mesh through that additional component.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom” or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A non-occluding earphone comprising:
a device housing defining an internal cavity, wherein the device housing includes an ear-interface portion having an asymmetric shape;
an acoustic port formed through the ear-interface portion;
a port mesh disposed across the acoustic port forming a portion of an exterior surface of the earphone;
an audio driver disposed within the internal cavity and aligned to emit sound through the acoustic port via a speaker acoustic path that extends from the audio driver through the port mesh and the acoustic port to a point external to the earphone;
a microphone disposed within the internal cavity; and
a microphone assembly coupled directly to the port mesh and disposed within the internal cavity at a location between the port mesh and the microphone, wherein the microphone assembly defines a microphone acoustic path from a point external to the earphone through the port mesh to the microphone that is fluidly isolated, within the internal cavity, from the speaker acoustic path up until the port mesh.

2. The earphone of claim 1, wherein the microphone assembly includes an acoustic mesh spaced from the port mesh.

3. The earphone of claim 2, wherein the microphone assembly includes a hydrophobic membrane spaced from the acoustic mesh.

4. The earphone of claim 3, wherein the acoustic mesh is positioned between the hydrophobic membrane and the port mesh.

5. The earphone of claim 3, wherein the microphone assembly includes one or more shim layers positioned between at least one of the acoustic mesh or port mesh.

6. The earphone of claim 5, wherein the one or more shim layers includes a plastic material.

7. The earphone of claim 5, wherein the microphone assembly includes chemically-resistant adhesive layers adhering the one or more shim layers to adjacent layers.

8. The earphone of claim 5, wherein the microphone assembly defines the microphone acoustic path through the acoustic mesh, the hydrophobic membrane, and the one or more shim layers to have a tortuous path.

9. The earphone of claim 1, wherein the microphone forms an air-tight seal with the microphone assembly.

10. The earphone of claim 1, further comprising a cowling coupling the microphone to the microphone assembly.

11. The earphone of claim 10, wherein the cowling includes a first cowling portion coupled to the port mesh and a second cowling portion coupling the microphone to the microphone assembly.

12. The earphone of claim 11, wherein the first cowling portion lies along a first plane and the second cowling portion lies along a second plane offset from the first plane.

13. The earphone of claim 1, further comprising a processor that is configured to execute instructions to provide active noise cancellation.

14. An earphone having an unsealed acoustic architecture comprising:
a device housing defining an internal cavity;
an acoustic port formed through a wall of the device housing;
a port mesh disposed across the acoustic port forming a portion of an exterior surface of the earphone;
an audio driver disposed within the internal cavity and aligned to emit sound through the acoustic port via a speaker acoustic path that extends from the audio driver through the port mesh and the acoustic port to a point external to the earphone;
a microphone disposed within the internal cavity; and
a microphone assembly coupled directly to the port mesh and disposed within the internal cavity at a location between the port mesh and the microphone, wherein the microphone assembly defines a microphone acoustic path from a point external to the earphone through the port mesh to the microphone that is fluidly isolated, within the internal cavity, from the speaker acoustic path up until the port mesh.

15. The earphone of claim 14, wherein the microphone assembly includes an acoustic mesh spaced from the port mesh and a hydrophobic membrane spaced from the acoustic mesh.

16. The earphone of claim 15, wherein the acoustic mesh is positioned between the hydrophobic membrane and the port mesh.

17. The earphone of claim 15, wherein the microphone assembly includes one or more shim layers positioned between at least one of the acoustic mesh or port mesh.

18. The earphone of claim 14, further comprising a cowling coupling the microphone to the microphone assembly.

19. An earphone comprising:
a device housing defining an internal cavity, wherein, when the earphone is fit within an ear of a user, all acoustic air volumes within the internal cavity has a free-flowing air path to an ambient environment external to the earphone;
an acoustic port formed through a wall of the device housing;
a port mesh disposed across the acoustic port forming a portion of an exterior surface of the earphone;
an audio driver disposed within the internal cavity and aligned to emit sound through the acoustic port via a speaker acoustic path that extends from the audio driver through the port mesh and the acoustic port to a point external to the earphone;
a microphone disposed within the internal cavity; and
a microphone assembly coupled directly to the port mesh and disposed within the internal cavity at a location between the port mesh and the microphone, wherein the microphone assembly defines a microphone acoustic path from a point external to the earphone through the port mesh to the microphone that is fluidly isolated, within the internal cavity, from the speaker acoustic path up until the port mesh.

20. The earphone of claim 19, wherein the microphone assembly includes an acoustic mesh spaced from the port mesh and a hydrophobic membrane spaced from the acoustic mesh.
